(19) United States
(12) Patent Application Publication
(10) Pub. No.: US 2007/0284314 A1
(43) Pub. Date: Dec. 13, 2007

(54) Oxidation Process for Water Treatment

(76) Inventors: Danielle Miousse, Quebec (CA); Fabienne Biasotto, Quebec (CA); Serge Labbe, Quebec (CA)

Correspondence Address: FAY SHARPE LLP, 1100 SUPERIOR AVENUE, SEVENTH FLOOR, CLEVELAND, OH, 44114, US

(21) Appl. No.: 10/565,090

(22) PCT Filed: Jul. 15, 2004
(86) PCT No.: PCT/CA04/01045

§ 371 Date: Jan. 5, 2007

Related U.S. Application Data
(60) Provisional application No. 60/487,947, filed on Jul. 18, 2003.

(51) Int. Cl. C02F 1/32; C02F 1/72

(52) U.S. Cl. 210/748

(57) ABSTRACT

The present invention relates to a process for the treatment of water containing a contaminant, said process comprising the steps of: (a) adding a sufficient quantity of hydrogen peroxide to the water; and (b) radiating the water with ultraviolet rays during a sufficient time for allowing decomposition of the contaminant until said treatment is achieved.

### BACKGROUND OF THE INVENTION

(a) Field of the Invention

This invention relates to a new oxidation process for the treatment of water, more specifically for the treatment of industrial process effluents.

(b) Description of Prior Art

The commercially available techniques for treating an effluent containing penetrant are mostly separation techniques. Filtration using activated carbon will provide satisfactory results with regard to the removal of the organic charge. However, the activated carbon is saturating quickly, resulting in high maintenance and disposal costs. Membrane filtration is also providing satisfactory results with regard to the removal of the organic charge, but is having the drawback of requiring high investment and maintenance costs.

It is known to use coalescers for removing oils and fat content from water. However, this method is not providing elimination of dissolved compounds and solid particles in suspension.

It is also well known to use ozone for treating penetrant containing effluents. This technique is efficient for removing the color of the penetrant, but is not adapted to reach high levels of reduction of the penetrant in water.

Bactericide capacity of UV is well known for treating water. UV rays having a wavelength of 254 nm are known to alter the chemical structure of the constituents of living cells. This leads to a dysfunction of the cell resulting in sterilization and destruction of the cell. The drawback of this technique is that the UV action is not remanent. UV treatment at 254 nm must therefore be used in combination with another treatment. UV treatment at 185 nm is less used and is a more recent development. These UV lamps can produce oxidative species that are highly reactive like ozone and hydroxyl-radicals. UV treatment is mostly used in the optic field to degrade organic matter and reduce the organic carbon content in water.

It is highly desirable to develop a new process for the treatment of an industrial effluent, more specifically an effluent containing penetrants.

### SUMMARY OF THE INVENTION

In accordance with the present invention there is provided a process for the treatment of water containing an organic contaminant, said process comprising the steps of:

(a) adding hydrogen peroxide to the water; and

(b) irradiating the water with ultraviolet rays during a sufficient time for allowing decomposition of the contaminant until the treatment is achieved. However, the process can be initiated by step (b) followed by step (a) or having steps (a) and (b) performed simultaneously without prejudice to the quality of the water treatment.

The ultraviolet rays are preferably of a wavelength of 185 nm.

In one embodiment of the present invention, the contaminant is miscible with water.

In another embodiment of the present invention, the contaminant is selected from the group consisting of fluoresceine, benzene or derivative thereof, phenol or derivative thereof and hydrocarbon.

In a further embodiment of the present invention, a step of passing the water in a coalescer to remove floating oils precedes step a).

In a still further embodiment of the present invention, a certain amount of hydrogen peroxide is added to initiate a phase separation. The phases are preferably separated into an aqueous phase and an organic phase.

In the present invention, it is intended that the duration of the treatment should be interpreted as being the circulation time in the UV reactor in presence of H₂O₂ that is necessary to obtain an emulsion comprising an organic phase (oil) and an aqueous phase.

The treatment of the water is intended to mean the treatment of the water in order to obtain a treated water having a reduced concentration of contaminant, or a complete elimination of the contaminant, in order to satisfy local environmental requirements.

The charge of the equivalent aqueous phase is the concentration of total organic carbon of the aqueous phase after separation from the organic phase.

The term “volume of H₂O₂ required” is intended to mean the H₂O₂ volume that must be added initially in the reactor per liter of solution for treatment.

It is intended in the present application that the term “equivalent organic charge” means the concentration of total organic carbon corresponding to the concentration in volume percentage (volume of contaminant per volume of solution).

It is also intended in the present application that the term “total organic carbon (TOC)” means the sum of all organic carbon present in a solution.

### BRIEF DESCRIPTION OF THE DRAWINGS

FIG. 1 illustrates a diagram of the steps of the process of the present invention;

FIG. 2 illustrates a flow-chart diagram of the process of FIG. 1; and

FIG. 3 illustrates the variation of TOC with time for different solutions having various TOC initial concentrations.

### DETAILED DESCRIPTION OF THE INVENTION

In accordance with the present invention, there is provided a new process for treating an effluent contaminated with organic matter using the combined effect of hydrogen peroxide (H₂O₂) and irradiation by UV rays (185 nm).

The process of the present invention combines the use of ultraviolet (UV) rays and the use of hydrogen peroxide to treat contaminated water. This water can be contaminated by an organic compound such as, but not limited to, fluorescein. This water is often characterized by an undesirable color, a variable organic charge, an absence of suspended matter and a fatty content being outside the acceptable limits for discarding in a wastewater system (30 mg/L).

In the process of the present invention, the UV treatment is coupled with the degradation effect of hydrogen peroxide. When the hydrogen peroxide is coupled to UV, the action of ozone on the dissociated form of peroxide generates hydroxyl-radicals and oxygen. These compounds attack the organic matter and propagate the chain radical mechanism as per the formula:

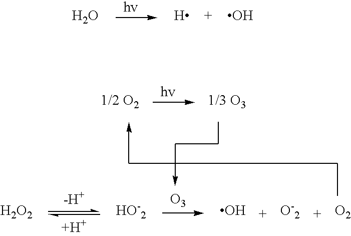

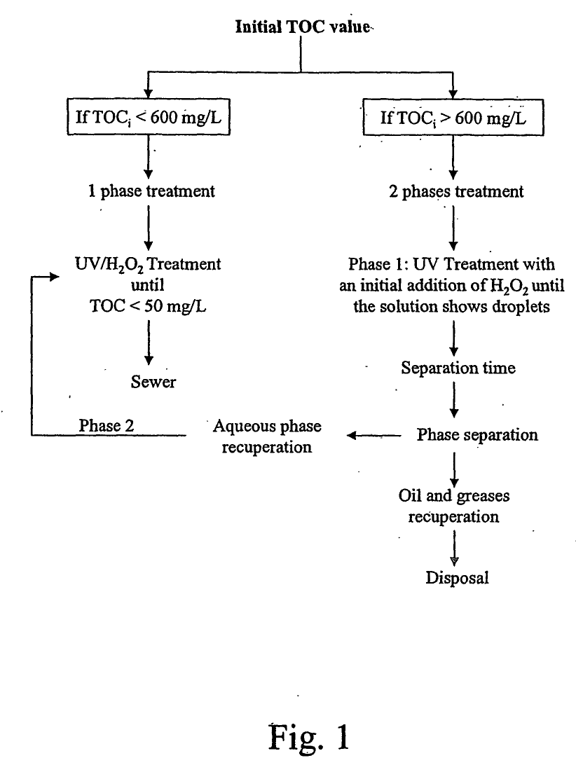

FIG. 1 illustrates the process used which is dependent on the initial Total Organic Carbon (TOC) measure. For TOC measures greater than 50 mg/L and less than 600 mg/L, the effluent is treated with UV at 185 nm and H₂O₂ is performed until the TOC value is less than 50 mg/L. The treated water can then be sent to the sewer. For TOC measures over 600 mg/L, two treatment phases are performed. In a first step, the water is treated with UV at 185 nm and H₂O₂ until an emulsion is formed. Table I provides the treatment time necessary to obtain phase separation for a three liter volume of a solution containing a certain fraction of contaminated water. When the emulsion is formed, the solution stays in tank (32) without agitation until the two phases are clearly separated. After that time, the fatty liquid phase can be retrieved and properly disposed. The aqueous liquid phase is having at this stage a TOC content much lower than the initial one and the second step of treatment consisting of UV and H₂O₂ treatment is performed as previously described.

TABLE 1
Treatment time for phase separation in a 3 liter solution

| | | | | H₂O₂ | |
|---|---|---|---|---|---|
| | | | | volume | |
| Contaminated | | | | (mL/L of | TOC of the |
| water | TOC | Treatment | | treated | aqueous |
| concentration | (ppm) | time | | water) | phase (ppm) |
| 0.15% | 710 | 30 | min | 5 | ≈230 |
| 0.20% | 930 | 40 | min | 6.7 | ≈280 |
| 0.25% | 1100-1200 | 50 | min | 8.3 | ≈300 |
| 0.30% | 1400 | 1 | hour | 10 | ≈350 |
| 1% | 4300-4600 | 3 | hours | 23.8 | ≈600 |
| 2.5% | 11000 | — | | 23.8 | ≈1200 |
| 5% | 22000 | 15 | hours | 47.6 | ≈2500 |

Treatment using H₂O₂ and UV continues until a satisfactory TOC value is achieved, preferably under 50 mg/L.

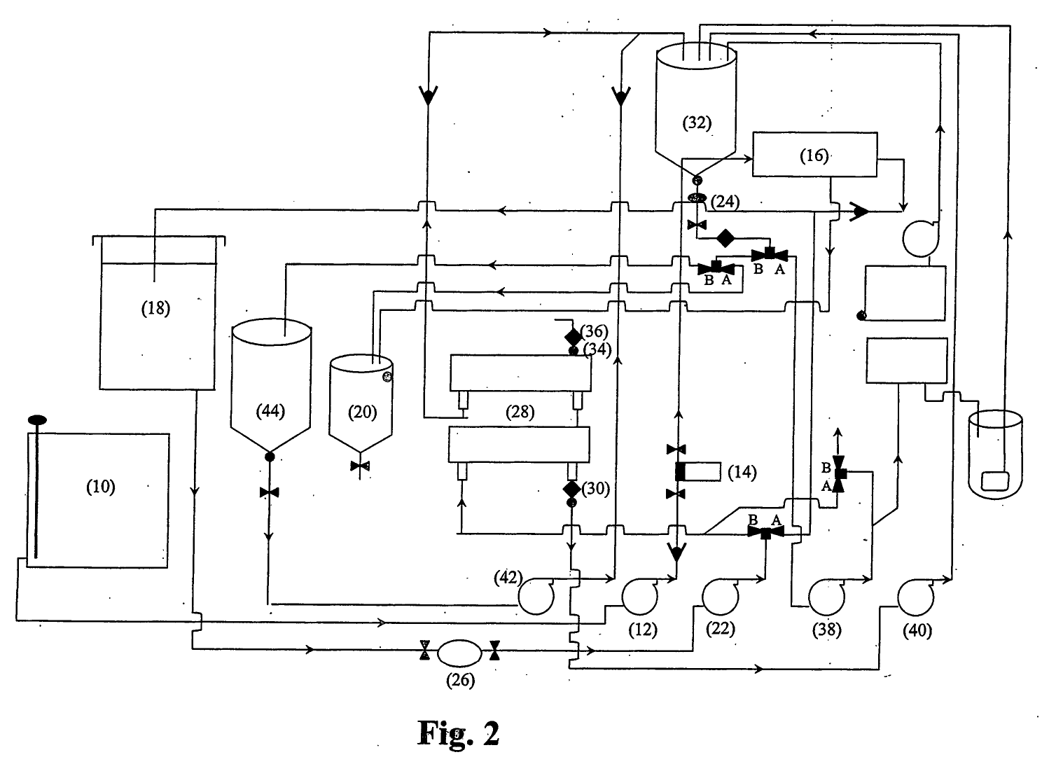

FIG. 2 shows the details of the process of the present invention.

Transfer of the Effluent from the Recuperation Tank to Intermediate Tank

The transfer of water to be treated is made from a recuperation tank (10) by a pump (12). The pumped water passes through a filter (14) and a coalescer (16). The filter (14) is used to eliminate large particles and to avoid damage to the equipment. At the exit of the coalescer (16), the residual water is transferred in the intermediate tank (18) by gravity and the oil is directed to an oil recuperation tank (20).

The intermediate tank (18) allows the accumulation of the non-treated water that may occur in the case of a prolonged interruption of the treatment. The homogenization of the water is provided by the pump (22). This recirculation allows a significant value of TOC to be achieved.

Transfer of the Effluent from the Intermediate Tank to the UV Reactor

The volume of water is controlled by the pulsed flow meter (26) and is directed to the UV reactor (28) through the pump (22). A fraction of the volume can be directed to a tank (32). The filling of the reactor (28) is provided by the captor (34) and the opening of the gate (36). Recirculation is provided in the reactor and the tank by the action of the pump (38).

Treatment of the Water with a Phase Separation

The duration of the treatment depends on the TOC concentration of the effluent. The quantity of H₂O₂ that must be added to the water is proportionally related to the initial TOC. Examples are given in Table 1.

Upon formation of the emulsion, all water contained in the UV reactors (28) is sent in tank (32) using pump (40) and left to rest for a pre-determined period of time. After that resting time, the two phases are well separated. The aqueous phase is transferred to tank (44) and the organic oily phase is transferred to tank (20) by gravity. The detection of the organic phase is achieved using an optical sensor (24).

The aqueous phase contained in tank (44) is sent back to tank (32) and UV reactors (28) using pump (42) in order to start a new treatment. H₂O₂ is added to the aqueous solution and UV radiation at 185 nm is applied. The TOC value is monitored and the treatment with H₂O₂ and UV rays continues until the TOC value meets the required value. The treated water is then returned back to the tank (32) to be eventually sent to the sewer.

Treatment of the Water without a Phase Separation

If the initial TOC value is under a predetermined limit, preferably 600 mg/L, the water is treated as previously mentioned but with no emulsion formation and no separation step.

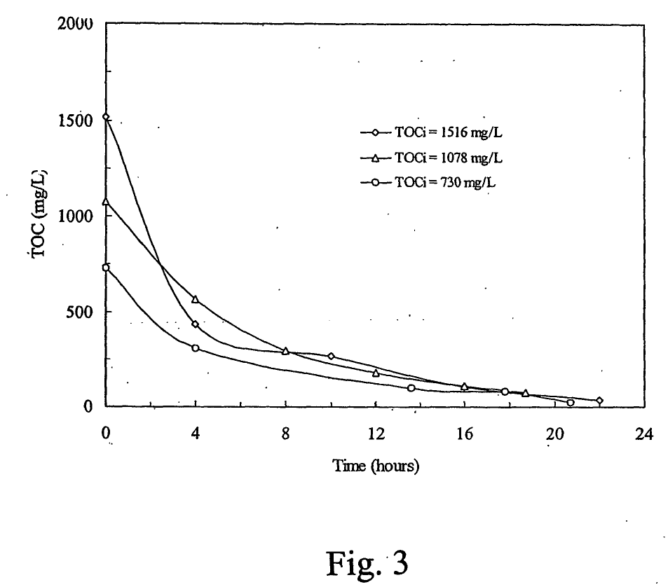

FIG. 3 illustrates the variation in TOC with time for solutions having various TOC initial concentrations. It can be observed that the addition of the phase separation step allows the treatment of solutions having a high TOC initial concentration in about the same time as needed for solutions having a lower TOC initial concentration.

While the Invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains, and as may be applied to the essential features hereinbefore set forth, and as follows in the scope of the appended claims.

1. A process for the treatment of water containing a contaminant, said process comprising the steps of:
(a) adding a sufficient quantity of hydrogen peroxide to the water; and
(b) radiating the water with ultraviolet rays during a sufficient time for allowing decomposition of the contaminant until said treatment is achieved.

2. The process of claim 1, wherein said ultraviolet rays are of a wavelength of 185 nm.

3. The process of claim 1, wherein said contaminant is miscible with water.

4. The process of claim 1, wherein said contaminant is selected from the group consisting of fluoresceine, benzene or derivative thereof, phenol or derivative thereof and hydrocarbon.

5. The process of claim 1, wherein step a) and step b) are performed simultaneously.

6. The process of claim 1, wherein said process is initiated with step b) followed by step a).

7. The process of claim 1, further comprising a step of passing the water in a coalescer before step a).

8. The process of claim 1, wherein said hydrogen peroxide is added until a phase separation is initiated.

9. The process of claim 8, further comprising the step of separating said emulsion into an aqueous phase and an organic phase after step b).

10. The process of claim 9, further comprising a step of using an optical sensor to isolate oils contained in said organic phase after the step of separating.
